(19) United States
(12) Patent Application Publication
(10) Pub. No.: US 2016/0358236 A1
(43) Pub. Date: Dec. 8, 2016

(54) RK Major Supplier Purchase Order Construction Process

(71) Applicant: Ram Katave, Dallas, TX (US)

(72) Inventor: Ram Katave, Dallas, TX (US)

(21) Appl. No.: 14/730,435

(22) Filed: Jun. 4, 2015

(51) Int. Cl. G06Q 30/06; G06Q 50/08; G06Q 10/08

(52) U.S. Cl. CPC G06Q 30/0609; G06Q 30/0637; G06Q 10/0875; G06Q 50/08

(57) ABSTRACT

This specific construction process is what I intend to patent the RK Major Supplier Purchase Order Construction Process is on the basis of a specific purchasing process between company representatives and specifically requested construction materials as stated in the contract with the contractor. The present invention discloses a system and method for purchasing construction materials and equipment between a customer and contractor's workers or construction company representatives. This construction process allows for the construction company to better micro manage construction needs. The RK Major Supplier Purchase Order Construction Process, which is more efficient than the “conventional” construction purchase process found in prior construction companies, the contractors employees or company representative must request materials in person and the materials will be deliver in bulk to a container on site or purchased at the store point of contact, with phone confirmation received in the form of a mutually issued purchase order unique identifier number. The RK Major Supplier Purchase Order Construction Process improves construction goals on the basis on micromanagement and increases quality assurance of materials and equipment during construction implementation.

### STATEMENT REGARDING FEDERAL SPONSORED RESEARCH OR DEVELOPMENT

Not Applicable

### REFERENCE TO SEQUENCE LISTING, ETC.

Not Applicable

### BACKGROUND OF THE INVENTION

This invention relates to construction management (hereinafter referred to as “RK Major Supplier Purchase Order Construction Process”) or otherwise known as “RK Purchase Order Construction Process”

The RK Purchase Order Construction Process has become increasingly popular in recent history. RK Purchase Order Construction Process involves at least two of three parties; each bilaterally agrees to perform certain duties as a result of purchasing materials usually without a terminable expected cost under contractual obligations. The object of the contractor is to apply or install a specific trade onto the customer or general contractors' projects' without incurring an implied employee relationship according to federal and state labor laws. As contractors' discretionary purchase need' increase, so has advancement in construction management processes.

Most construction companies use a conventional construction purchasing process for the application and installation of construction materials including assets by using conventional means. The RK Purchase Order Construction Process use phone confirmation to indirectly confirm materials purchase in order to consider workers subcontractors and use contracts; to increase performance and chance of risk liability.

Contractors' Companies' are also looking to increase jobsite purchases indirectly through a number of workers they have available without the need to fall under employee statutes.

The Engineer News Record 500 list construction companies who employ companies to perform functions on the construction project up until completion these may include a variation of the RK Purchase Order Construction Process. The RK Purchase Order Construction process is an innovation to allow a customer, general contractor, or developer to greatly increase the indirect control given over the structure of an independent contractor that must buy their own products in order to minimize liability loss. In coagulation with customer(s), these contractors have the requirement of needing hired workers that have a certain prior performance guarantee. Unlike a traditional construction company, however, these contractors commonly use state required laborers as a replacement if required by the state even though this will ascertain company employees will process the RK Purchase Order Process on these workers' behalf. The intersection of the new RK Purchase Order Process to replace what is previously found in a conventional company structure and the contractor found performing interchangeable purchase management tasks, which gave rise to the present invention.

The present construction management process relates to an improved way to purchase construction materials on behalf of a customer by a sub-laborer or hired worker or construction business through a defined contract's scope of work. Construction management purchasing processes have dramatically increased with improvement in demand and increasingly high end construction projects. The method of corporate structure for applicable RK Purchase Order Processes includes customer(s), contractor(s), and hired workers; one or more of which are additionally disclosed by Katave in U.S. Provisional Pat. No. 61,988,209. In existing developers and construction companies, there is a delay from the time the construction project begins in the approval process of determining the end results of the materials application or installation. The RK Purchase Order Processes may use contractors or hourly workers in representation of the contractor may perform purchasing in order to perform within the scope of work expressly agreed upon in the customer contract. The contractor then bridges the gap of expectations by paying for materials as explicitly stated in a contract with the customer. In addition, the contractor may sign a contractual agreement for the materials to be performed at a specific price with the supplier and may be required to pay for sundries. This gap in contractual performance becomes fulfilled with less liability and more expertise than traditional construction process considerations. The contractual performance may be binding upon two or more parties to include the responsibilities of purchasing acceptable materials. Since the customer's oversight of purchasing decisions is a limiting factor and also a determinant of a employer-employee relationship, there is an improvement in the liability, and oversight, between the contractor and customer with increase in construction performance.

### BACKGROUND OF THE INVENTION

The present invention preserves the construction management operation of contractor purchasing systems with majors suppliers. This operation can provide significant increases, via procedural design, in oversight, and liability of customer and Construction Company in comparison to prior art systems. By using the RK Purchase Order system between Customer and contractors, the present invention significantly reduces the liability which the customer undertakes in direct responsibility to the hired workers and thus, the need for greater exposure to casualties on the jobsite. The reduction of liability may only occur with a direct specification and order to the contractor relationship. The weaknesses for liability suits are eliminated with the elimination of the conventional construction process between the customer and the employees. While the employees or hourly workers execution of the contractor's purchasing duties may be misconstrued as direct representation, the special performance contracts between all three parties (customer, subcontractor, and specialized contractor) presuppose the payment by the contractor; initial preparation efforts required by the contractors and set up the contractor in a zero sum gain. Unlike prior art devices, this invention allows the construction company to replace labor onsite by request of a customer; therefore, the contractor participates in oversight of materials virtually instantaneously.

Specific application performance contracts between contractors and hourly workers or hired workers is achieved by a customer contract, contractor or subcontractor change order request, or addendums to both new and upcoming projects via direct attachment to an online bidding process or otherwise software program (ex. Isqft). The effect on material purchasing is recorded and may include customer requests for large orders through the major supplier or account representative.

An object of the present invention is to provide a process and system of construction management purchasing advances to initiate the material management process in execution sequence on behalf of a customer.

It is a further object of the present invention to provide a representative to pickup materials this could be a representative of an indirectly hired labor force for the contractual fulfillment of a trade application specialty (such as paint, steel, or concrete) and/or installation to control construction performance (such as elevation, plumbing, electrical, or air conditioning) systems. These and other features, aspects and advantages of the present material purchase invention will become better understood with reference to the following description, appended claims and accompanying drawing.

### BRIEF DESCRIPTION OF THE DRAWINGS

FIG. 1: Illustrates the construction process of the invention

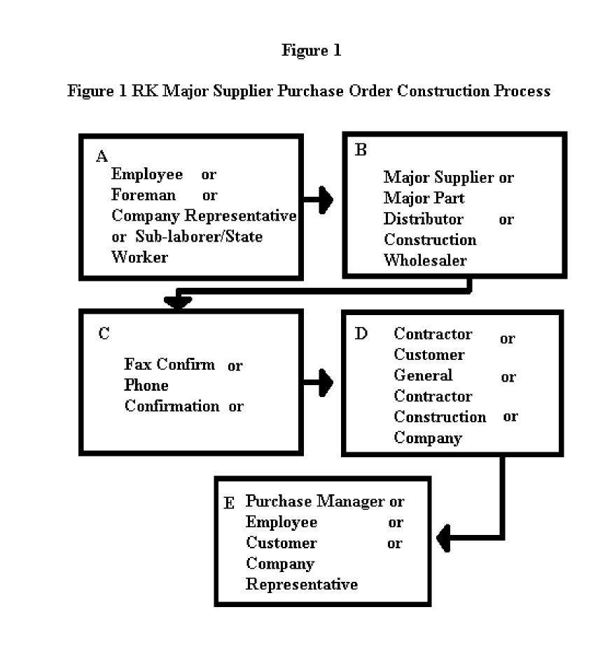

### DESCRIPTION

This invention provides a means for material management between the customer (i.e. developer, general contractor, or owner representative) in a construction project and special trade company (“contractor”). The construction guidelines between the customer and contractor may include handwritten, email, or fax means.

In well known and common construction companies, an ongoing labor force resides within the contractor's hourly workers'. This construction relationship as defined in contract includes labor and material costs, adjusts and determines updated price adjustments as necessary, and sends a final contract. This construction agreement accepts customer and worker material purchase decisions, alters and includes alterations as necessary and sends construction company representatives pay or control the hired workers' or hourly workers' construction sequence.

The present invention provides an embodiment for integration of purchase monitoring with major suppliers from the customer specifications located in the construction performance agreement (s). An additional output may be leveraged through retainer, bond, and/or specified damage terms by a customer's contractual obligations. In the circumstance where the customer or contractor resides outside of the said construction site's state, the contractor will likely use a local construction company's license to represent execution of construction contract obligations. The contractor will apply the RK Purchase Order process between the major supplier Supplier and the out of state workers.

In well known and common construction companies, a hired work force resides within the company that can make purchasing decisions. The salary or hourly workers will buy materials at the expense of the employer; however, hourly workers accept construction requests on an hourly basis from their contractors directly under these construction customers. The conventional construction company may even compensate workers for sundries while they themselves pick up the larger paint orders and deliver to their storage container available on the construction site. This conventional process lacks an efficient follow through with the capacity for liability at every step of the material coordination process. The material purchases from the hired workers may causes an application or installation of construction work on a specifically mentioned construction site if contractually stated. The contractor is directly not indirectly connected to hired or hourly workers which apply or install the customer's assignment to contractor.

The output from the customer enables the hourly workers to progress with authorization implicitly received on materials after the customer sample application is approved. The phase completion is directly or indirectly connected to the release of payments by the customer, subcontractor, or contractor directly to the workers hourly. The preferred embodiment of the present invention allows for additional hourly workers to indirectly perform customer assigned tasks. Additional hired or hourly workers may either replace hired workers used in prior work currently on site or to expedite the customers' needs my request additional monies if there is a change to materials in architectural scope.

The additional contractor will exist as a medium for hired worker execution. In the circumstance in which the contractor resides outside of the construction location's primary state, the contractor will likely utilize a system similar to the RK Purchase Order Process even if there are alternatively existing sub-specialty contractor licenses on the state's contractor's licensing board.

The contract between the customer and contractor must first establish a sale price for work performed per square foot to prevent unintended loss from construction on site. The calculation of materials is an additional agreement between the contractor and the major material or equipment supplier. After this common agreement is established, the contractor will organize the labor to the construction site before, during, or after the first construction day price is a negotiated agreement despite the potential for an annual price list. The contractor's material purchase execution may be started, aborted, or repeated at any point throughout the construction life cycle even though time is of the essence. In the preferred embodiment, the hired workers or hourly workers will execute the construction approximately entirely without supervision directly from customer.

Once the contractor's contract proceeds through each construction phase, the customer releases a payment that is processed onto the hired or hourly workers via the contractor that covers materials and profits. If the contractor chooses to accept and process the contractor's construction agreement from the customer, the hired or hourly workers on assignment will directly or indirectly manage most application or installation tasks associated with trade completion or the employees will purchase site materials. At this point, the prior art construction management sequence resumes as the contractor proceeds to hire salaried workers directly to feed the execution of their special trade's application or installation. The construction business owner will directly purchase the sundries and materials with no discretion carried over to the workers underneath. After receipt of the materials purchased by the employees or company representatives through a fax to the contractor, the employees receive pick up the materials to take for the jobsite. On occasion, the bulk order for paint and materials will be sent to an assigned container on the construction site. The conventional construction business owner does not compensate working companies for materials spent and the customer is legally bound to disperse payment in accordance with Federal and State labor laws. The utilization of the preferred embodiment of the present invention eliminates the need for “conventional” construction management material purchase concerns between the customer and the hired workers or workers hourly. The exception to this is litigation according to some state labor laws.

Even though the present invention has not been described in expansive detail with reference to certain preferred versions thereof, other versions are possible. Therefore, the spirit and scope of the appended claims should not be limited to the description of the preferred version contained herein.

What is claimed is:

1. A contractor purchase order process comprising: a) contractor or specialty trade company with hired workers or (“employees”), a contract that specifies the provision of labor, said contractor including a negotiated fixed price contract with a major material or equipment supplier;
b) A contractor process (“construction company”) who has signed hourly laborers for work performance to complete contractual terms on a recorded hourly basis, said construction company (contractor) having a written agreement with the customer but not otherwise signed construction agreements with hired workers or employees in accordance with the work expressly written in the contract, said contractor further having may been assigned material provision expectations within the contract; c) A means with which can coordinate a purchase that is overseen by headquarters between any given worker or company representative and any location of the major supplier; d) The Contractor performs the work assigned by directly hiring workers and/or by purchasing materials on behalf of a customer. The contract signed by the general contractor or customer with the contractor, which the hourly workers may act upon, and cause hourly workers to apply materials on the construction site, said means including oversight in said specialized work that, when said contractor receives construction permission, sends hired workers to said construction site reflecting at least one or more of “jobsite requirements” to begin the application or installation of the construction need as specified in the contract between the general contractor or customer and the contractor. Contractor having said supervisory rights to evaluate work at each phase turn over before processing payment hourly workers. The construction applied by “hired workers” through the contractor agreement must reflect work only as expressly stated in the contract between the general contractor or customer and the customer, and to ignore any construction work that does not include contractual obligation. The construction supervised by “contractor” through the contract agreement.

2. The process of claim 1 wherein the customer is property owner, developer, and/or general contractor to the contractor as opposed to a direct hiring of hourly workers.

3. The process of claim 1, wherein said materials purchased reflect at least one or more of the specified materials is desired by said architect/customer as a result of previously requested materials in order for the contractor to meet the provisions of construction terms.

4. The process of claim 1, wherein said contract specialized between general contractor/customer to contractor and said hired workers or hourly workers are at least substantially identical to material/equipment purchases in location for labor execution and supplier purchase representation.

5. A construction system, comprising: a developer or general contractor; hired or hourly workers by a specialized contractor on behalf of a customer's contractual agreement; wherein said hired workers fulfill the contractual obligations on behalf of the contractor by visiting a major supplier's location and requesting materials or equipment in person. The major supplier will call the contractor to verify the materials and purchase amount. The contractor will co-assign a purchase order number and may record the material purchase for work in progress bookkeeping. The hired workers or contractor's company's representatives will then take the material or equipment purchase to the construction site for application purposes. The customer then disburses payments after application phase evaluation with the customer, developer, or general contractor.

6. The process of claim 5, wherein said hired workers or hourly workers may purchases materials indirectly through the “contractor”, said customer choose materials (sundries) to complete construction and to ignore at least responsibility for purchase, said purchase will charge to the contractor or customer. The customer does not pay for materials or products installed by said hired workers on behalf of the contractor or specialized trade contractor.

7. The process of claim 5, wherein said materials are pre-approved by customer and contractor, said materials will be expressly stated by contract with terms of obligations for purchase requirements.

8. The process of claim 5, wherein said materials or equipment through the contractor may be monitored by contractor and customer, said hired workers may be given specific direction so as to protect customer from injury or liability. Contractor representatives and hired workers supervise the construction process.

9. The process of claim 5, wherein one or more hired construction material or construction equipment purchases does not alter utility of said construction process in a specific industry. If so, the contractor may be liable for any misapplied materials on the jobsite similar to a conventional construction company.

10. The process of claim 5, wherein one or more “change orders” to architectural scope is represented by additional “purchase orders”, said contractor may directly purchase materials or equipment on behalf of the customer or general contractor that is hired by said developer.

11. The process of claim 5, wherein hourly workers or specialized workers represent one or more construction site purchases approved by general contractor or customer to the contractor responsible. The construction site obligations for material delivery are followed through with supervision by contractor, general contractor, and owner's representative with certain OSHA standards.

12. The process of claim 5, wherein said contract includes at least an estimate of materials or equipment purchase by contractors on behalf of the general contractor or customer as specified in claim 1.

13. The process of claim 5, wherein reimbursement of additional construction materials by general contractor to contractor on behalf of a customer may follow the construction process patent design terms in contradiction of architectural scope drawings.

14. The process of claim 5, wherein the entire process for major supplier purchase of the construction process may be started, aborted, or repeated at any point throughout the construction life cycle.

15. The process of claim 5, wherein contractor B said and said hired workers C are at least substantially accountable to the general contractor or through the specialized contractor in terms of material application performance as well as supplier warranty.

16. The process of claim 5, wherein hired workers C said and said hourly workers C are at least substantially identical in duties performed throughout the RK Purchase Order System life cycle.

17. The process of claim 5, wherein contractor B said and said workers C are at least substantially accountable to the general contractor or customer through the contract in terms of materials and equipment work performance.

17. The process of claim 5, wherein said contractors include an additional contractor between said contractor and hired workers does not alter this purchasing procedure. There is no exception even in the case of an “in-house” wholesaler that partakes in logistical coordination to jobsites.

18. The process of claim 11 wherein said operational process includes at least contractual obligations for specific materials within customer's written execution of contract construction performance agreement with developer and contractor to meet state requirements for materials applied in the specifications of building plans (blueprints).

19. The process of claim 17 wherein said operational process includes at least an alteration to the final cost of the materials performed by said contractor B or said hourly workers if expected work performed on site increases and/or adjusts in service.

20. The process of claim 19, wherein the creation of the adjustment in materials price is considered a “change order” to the final cost of the work amount billed by the contractor to the customer. The customer is defined by claim 1.

21. The worker's purchasing through the RK Major Supplier Purchase Order Process may also be referred to as laborers, employees, contractor's representatives and hourly workers.
